(19) United States
(12) Patent Application Publication
(10) Pub. No.: US 2026/0322592 A1
(43) Pub. Date: Oct. 15, 2026

(54) ON-THE-FLY PROVISIONING OF CLIENTS USING PRIVATE NETWORK PROTOCOLS

(71) Applicant: Tailscale Inc., Toronto (CA)

(72) Inventor: Bradley J. Fitzpatrick, Seattle, WA (US)

(21) Appl. No.: 19/467,409

(22) Filed: Feb. 2, 2026

Related U.S. Application Data
(60) Provisional application No. 63/752,384, filed on Jan. 31, 2025.

(51) Int. Cl. H04L 9/08; H04L 9/30; H04L 9/32; H04L 9/40

(52) U.S. Cl. CPC H04L 9/0825; H04L 9/30; H04L 9/3213; H04L 9/40

(57) ABSTRACT

The technology disclosed herein enables on‑the‑fly establishment of private network connections between computing elements. In one example, a method includes advertising, from a first computing element, private communication information comprising a first public key for encrypting encapsulated enrollment messages and a public Internet Protocol (IP) address of the first computing element. The method further includes receiving, from a second computing element, an encrypted message that includes a second public key, and decrypting the message using a private key corresponding to the first public key. In response, the first computing element generates a secure token and provides the secure token and a public key to the second computing element for subsequent communications. The method also includes performing a Network Address Translation (NAT) handshake between the first and second computing elements using the secure token for authentication and the public key to encrypt communications directed to the first computing element.

### RELATED APPLICATIONS

This application is related to and claims priority to U.S. Provisional Patent Application 63/752,384, titled “ON-THE-FLY PROVISIONING OF CLIENTS USING PRIVATE NETWORK PROTOCOLS,” filed Jan. 31, 2025, and which is hereby incorporated by reference in its entirety.

### BACKGROUND

Organizations increasingly rely on devices that move between heterogeneous networks—home routers, enterprise firewalls, carrier‑grade NATs, and guest Wi‑Fi—where address translations, filtering rules, and link variability routinely break direct connectivity or cause it to flap during normal operation. Conventional private‑network setups often assume static configuration, pre‑registered peers, or continuous availability of a central coordinator; when these assumptions fail, onboarding new devices can require manual key exchange, ad‑hoc port forwarding, or permanent reliance on intermediary infrastructure. Environments with mixed trust levels also raise additional needs: authenticating unknown or newly introduced devices without exposing long‑lived secrets, rotating keys and revoking access without downtime, and preventing lateral movement so that clients cannot discover or communicate with one another. At the same time, operators want resilient communications that prefer direct paths when possible, yet remain usable when NAT behavior, symmetric mappings, or restrictive policies prevent hole‑punching. A background challenge, therefore, is to establish private, authenticated, and confidential connectivity between devices that may not be pre‑registered, may be behind independent NATs, and may experience changing reachability—while enabling discovery, enrollment, policy enforcement, and optional use of intermediary paths—without imposing brittle configuration steps or dependence on a single coordinating service.

### SUMMARY

The technology disclosed herein enables on-the-fly establishment of connections between communication elements using private network protocols. In a particular example, a method includes advertising, from a first computing element, private communication information including a first public key for encrypting data in encapsulated packets directed to the first element and a public Internet Protocol (IP) address of the first computing element and receiving a message at the first computing element from a second computing element. The message is encrypted using the first public key and includes a second public key for the second computing element. The method further includes decrypting the message at the first computing element using a first private key and, in response to receiving the message, creating a secure token and providing the secure token to the second computing element with a second public key. The method also includes performing a Network Address Translation (NAT) handshake between the first and second computing elements using the token for authentication and the second public key to encrypt communications directed to the first computing element.

### BRIEF DESCRIPTION OF THE DRAWINGS

FIG. 1 illustrates an implementation for on-the-fly provisioning a private network between computing elements.

FIG. 2 illustrates an operation to access external services from within a private network.

FIG. 3 illustrates an operational scenario for on-the-fly provisioning a private network between computing elements.

FIG. 4 illustrates an implementation for on-the-fly provisioning a private network between computing elements.

FIG. 5 illustrates an operational scenario for on-the-fly provisioning a private network between computing elements.

FIG. 6 illustrates an operational scenario for on-the-fly provisioning a private network between computing elements.

FIG. 7 illustrates a computing system for on-the-fly provisioning a private network between computing elements.

### DETAILED DESCRIPTION

Virtual Private Networks (VPNs) work by creating a logical network overlay that allows devices to communicate securely over underlying networks, such as a public or untrusted network (e.g., the Internet). The overlay is achieved through a process called encapsulation, where the data packets sent between devices are wrapped inside additional packets that include encrypted information. For instance, when a VPN endpoint device sends data through a VPN, a packet carrying the data is encrypted and then encapsulated with a new packet header that includes a public IP address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public infrastructure, providing privacy and security for users.

A Tailnet is a VPN created using Tailscale, which leverages the WireGuard protocol to provide secure, encrypted connections between devices. This network allows devices to communicate as if they were on the same local network, regardless of their physical location. Tailscale simplifies network management by eliminating the need for complex configuration or hardware setup, making it accessible for both individuals and organizations.

Nodes in a Tailnet are authenticated using a combination of modern cryptographic techniques and identity verification. Each device that joins a Tailnet must authenticate itself via an identity provider, such as Google, Microsoft, or Okta, which ensures that only nodes associated with authorized users can connect to the Tailnet. The authentication process involves exchanging cryptographic keys to establish trust between devices, ensuring that each node can securely identify and communicate with others within the network.

Once authenticated, each device receives an IP address unique within the VPN and becomes part of the Tailnet. This IP address is used to route traffic securely within the network, and all communication is encrypted using the WireGuard protocol, although, other protocols may be used. Even if devices are on different underlying public networks, their data remains private and secure. Continuous authentication and authorization controls may also be implemented. This means devices are regularly verified and permissions can be adjusted dynamically. If a device’s status changes or if the identity provider's credentials are updated, Tailscale can enforce new access policies in real-time, maintaining the network's security and integrity.

The above features of a VPN or Tailnet may not be available should an entity maintaining the network stop doing so (e.g., the entity may go out of business). The examples below describe how a private network between two devices can still be established even with a centrally managed private network is no longer available.

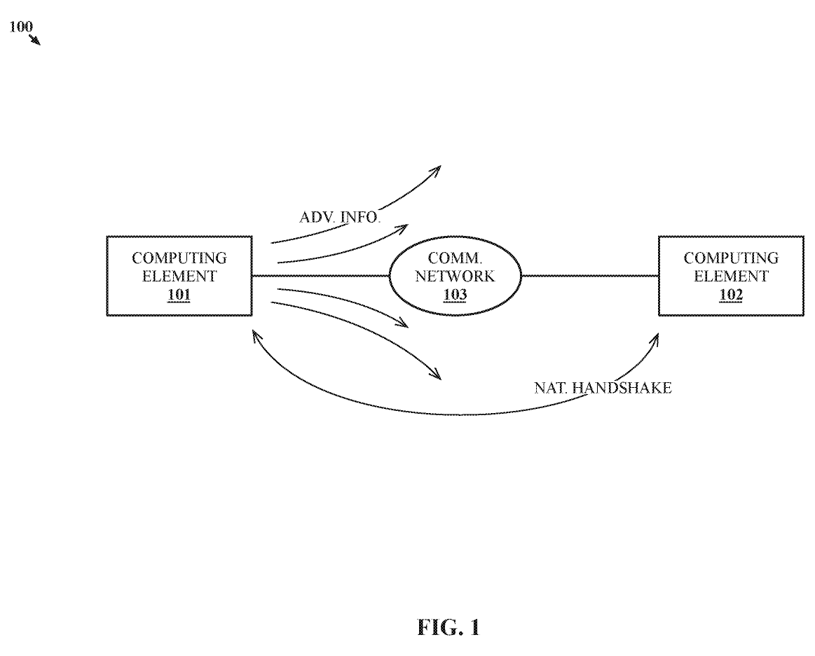

FIGS. 1 illustrates implementation 100 for on-the-fly provisioning a private network between computing elements. Implemented 100 includes computing element 101, computing element 102, and communication network 103. Computing elements 101 and 102 may be servers, desktops, laptops, smartphones, tablets, media streaming device, peripherals, or any other type of system or device that can connect to a communication network – including combinations thereof. For example, computing element 101 may be a server hosting data on behalf of a business, while computing element 102 could be an employee's laptop accessing internal applications. Communication network 103 connecting these elements may include components like routers, switches, firewalls, modems, and access points. These components may be part of one or more Local Area Networks (LANs), Wide Area Networks (WANs), including the Internet, or some other type of network configuration – including combinations thereof.

Implemented 100 lacks a central authority to establish and maintain a private network between computing element 101 and computing element 102. Communications between computing element 101 and computing element 102 may, therefore, lack the security provided by the private network. For instance, packet communications between computing element 101 and computing element 102 may not be encrypted and there may be no mechanism for ensuring the communications are even allowed.

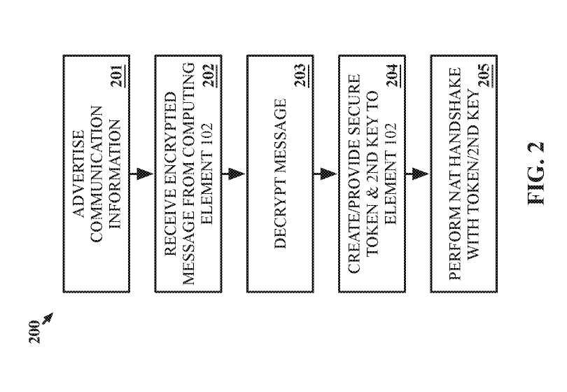

FIG. 2 illustrates operation 200 to access external services from within a private network. Computing element 101 advertises its private communication information, including its public IP address and a first public key, over communication network 103 (step 201). The public key can be used to encrypt data in encapsulated packets directed to computing element 101. In this case, the first public key is a public key that is to be used by computing elements requesting to establish a private connection with computing element 101. The IP address is public such that computing element 101 can be addressed from any element over communication network 103. Computing element 102 is a computing element that receives the advertised information from computing element 101 and sends an encrypted message back to computing element 101 using the first public key to encrypt the message. The encryption of this message using the first public key ensures that only computing element 101 can decrypt and read the contents. The message includes a second public key, which will be used to encrypt subsequent secure communications directed from computing element 101 to computing element 102.

Computing element 101 receives the encrypted message from computing element 102 over communication network 103 (step 202). Upon receiving the encrypted message from computing element 102, computing element 101 decrypts the message using a first private key that corresponds to the first public key (step 203). This decryption process allows computing element 101 to access the second public key provided by computing element 102 in the message.

Computing element 101 creates a secure token and provides the secure token with a second public key that computing element 102 can use for subsequent communications with computing element 101 (step 204). The secure token may be created in response to authenticating computing element 102 (or a user of computing element 102). The message from computing element 102 may provide authentication credentials (e.g., username and password) to validate that computing element 102 is allowed to access computing element 101. Alternatively, computing element 101 may employ an identity provider to authenticate computing element 102 or employ some other mechanism.

After computing element 102 receives the secure token, a Network Address Translation (NAT) handshake is performed between computing elements 101 and 102 (step 205). This handshake uses the secure token for authentication and the second public key to encrypt communications directed to computing element 101. The NAT handshake ensures that the private network is established securely, allowing both computing elements to communicate efficiently and securely over the communication network 103.

After computing element 102 receives the secure token, a Network Address Translation (NAT) handshake is performed between computing elements 101 and 102 (step 205). This handshake uses the secure token for authentication and the second public key to encrypt communications directed to computing element 101. The NAT handshake ensures that each device can locate and communicate with the other across different networks, despite potential address changes or network configurations. This secure mapping and exchange of information allow the private network to be established, enabling efficient and secure data transfer between the two computing elements over the communication network 103.

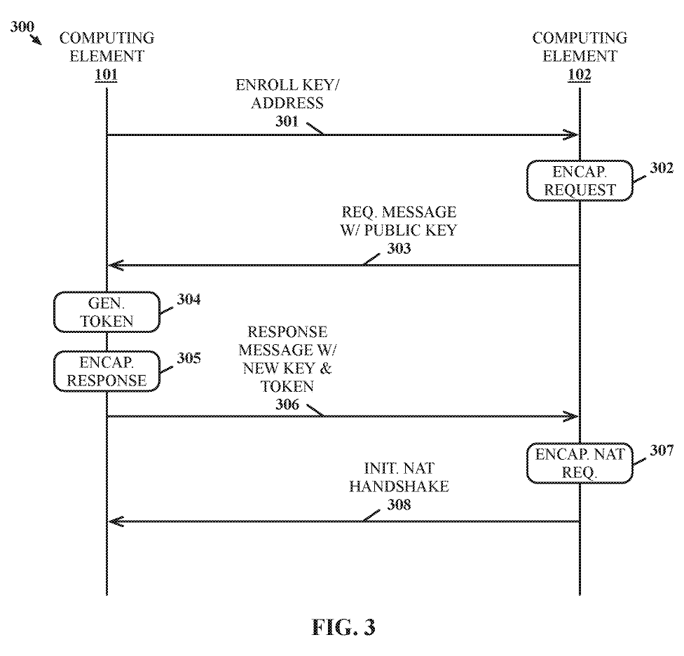

FIG. 3 illustrates operational scenario 300 for on-the-fly provisioning a private network between computing elements. Operational scenario 300 includes computing element 101 broadcasting the public key other computing elements should use to enroll (i.e., request a connection with computing element 101) and an IP address that can be used to send communications to computing element 101 (step 301). Computing element 102 encrypts and encapsulates an enrollment request using the public key supplied by computing element 101 for enrollment (step 302). The request message is sent to computing element 101 (step 303). Computing element 101 decrypts the request and generates a secure token (step 304). Computing element 101 encapsulates a response to computing element 102's request that includes the token and a new public key for computing element 102 to use (step 305). The response message is sent to computing element 102 (step 306). Upon receiving the response message, computing element 102 encapsulates a NAT request using the new public key (step 307). The request is sent to computing element 101 to initiate a NAT handshake with computing element 101 (step 308).

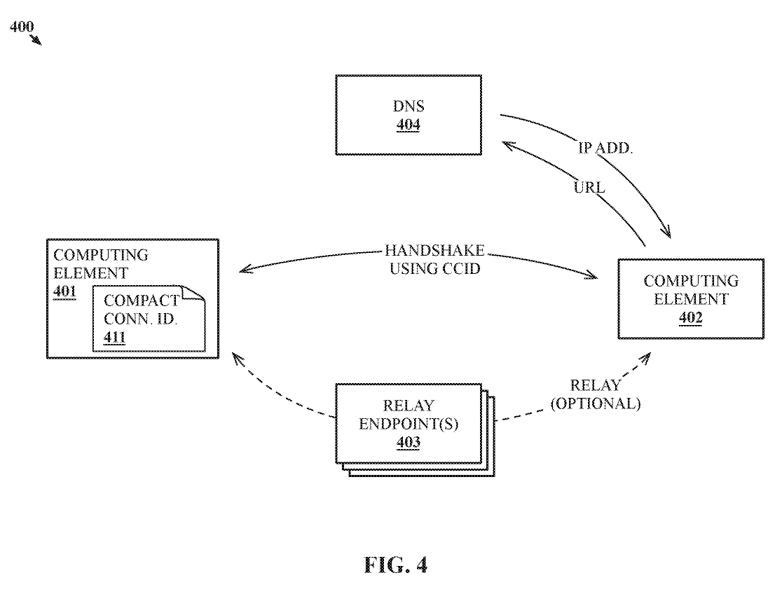

FIG. 4 illustrates implementation 400 for on‑the‑fly provisioning of a private network between computing elements. Implementation 400 includes computing elements 401-402, one or more relay endpoint(s) 403, and a name‑resolution service such as DNS 404. Computing element 401 advertises a compact connection identifier 411 that aggregates the private communication information a remote computing element needs to initiate enrollment and bootstrap connectivity. In one example, compact connection identifier 411 includes a first public key to be used for encrypting data in encapsulated enrollment messages directed to computing element 401, a public network address or hostname for computing element 401, and a list of relay endpoints 403 that can be used for bootstrap signaling or as a fallback path when a direct connection cannot be established. In another example, compact connection identifier 411 separates keys by role: an enrollment public key for messages that request admission and a traffic public key that will be used later for secured data communications. Separating these keys limits the exposure of long‑lived traffic keys and facilitates key rotation without interrupting existing private connections.

Compact connection identifier 411 can further include metadata that broadens the range of supported deployments. Metadata may include an expiration time to limit re‑use, a usage scope that constrains which resources may be accessed after enrollment, a revocation status or revocation pointer that can be consulted by a peer at connection time, and a digital signature allowing a receiving computing element to verify the authenticity of the identifier prior to initiating contact. The identifier may also carry endpoint descriptors describing connectivity candidates such as UDP and TCP ports, preferred transport profiles, or hints indicating whether a given endpoint is reachable only via a relay. To improve distribution, compact connection identifier 411 can be encoded as a printable character string, such as a base‑encoded text that is easy to copy/paste, or rendered as a machine‑readable visual code presented by computing element 401 on an attached display for scanning by computing element 402. In some embodiments, computing element 401 publishes compact connection identifier 411 or a resolvable reference to it as a record within DNS 404. For instance, a TXT record may embed the identifier itself, while an A/AAAA record returns a stable bootstrap address even if the ultimate traffic path will differ. The combination of self‑contained encoding and name‑resolution publication allows the system to function whether peers communicate an identifier out‑of‑band (e.g., via a QR code) or discover the identifier dynamically through DNS lookups, thereby accommodating preauthorized second computing elements, newly arriving second computing elements that are not pre‑registered, and deployments in which operators wish to admit a number of devices opportunistically.

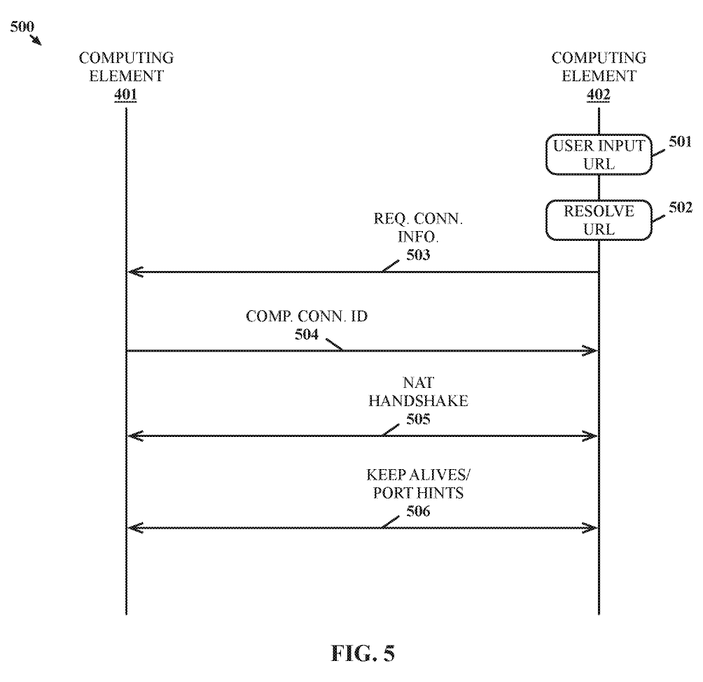

FIG. 5 illustrates operational scenario 500 for on‑the‑fly provisioning a private network between computing elements. In operational scenario 500, computing element 402 receives user input indicating a Uniform Resource Locator (URL) to create a private network connection with computing element 401 (step 501). The URL can be typed into a client application, scanned from a displayed visual code, invoked from an application deep link, or selected from a directory entry that the operator shares inside or outside the private network. Accepting multiple input modalities permits enrollment when little or no prior configuration is known and supports both interactive and automated provisioning flows. In some examples, the URL is a short, stable reference that resolves to compact connection identifier 411; in others, the URL embeds the identifier directly so that the client can proceed even when DNS is intermittently unavailable.

Computing element 402 communicates with DNS 404 to resolve an IP address of computing element 401 from that URL (step 502). In one example, DNS 404 returns both address records (e.g., A/AAAA) and metadata records (e.g., TXT) including compact connection identifier 411, an ordered list of candidate endpoints, and relay endpoint(s) 403. The client may prefer the endpoint with lowest expected latency, highest measured availability, or best policy fit. If DNS resolution fails or yields no usable candidate, computing element 402 may fall back to a previously cached compact connection identifier 411 or to a locally captured visual code. This flexibility allows the system to function across roaming scenarios and temporary outages.

Computing element 402 directs a request for connection information to the IP address (step 503). The request is typically an enrollment message encrypted using the first public key included with compact connection identifier 411, and includes at least a second public key of computing element 402 to be used for subsequent communications. In some cases, the enrollment message further carries an authentication credential (e.g., a user assertion, device certificate, or shared enrollment secret), enabling computing element 401 to determine whether computing element 402 is permitted to join. The enrollment message can be encapsulated for traversal through restrictive middleboxes (e.g., sent over a permitted protocol while preserving upper‑layer semantics) so that it can reach computing element 401 even when inbound traffic is not allowed.

Computing element 401 sends compact connection identifier 411 in response to the request (step 504). The response may confirm public key roles and provide a traffic public key distinct from the enrollment public key to isolate enrollment from traffic, as well as a secure token that authorizes the second computing element to proceed. The response can also include updated endpoint metadata, such as fresh candidate addresses, revised relay preferences, or cipher/transport capabilities, based on the current state of computing element 401 and observed network conditions. Providing these details improves connection success rates and enables adaptive behavior without central coordination.

Computing element 402 and computing element 401 perform a NAT handshake using compact connection identifier 411 (step 505). In one example, both elements perform simultaneous outbound connectivity attempts to a prioritized set of candidates, which increases the likelihood of establishing a direct path when one or both elements are behind NAT devices. The handshake authenticates signaling with the secure token and then transitions to encrypting subsequent communications using the traffic public key advertised by computing element 401 and the second public key supplied by computing element 402. During the handshake, the peers may probe multiple ports or protocols as suggested by endpoint descriptors to accommodate diverse NAT behaviors.

In this example, after the NAT connection is established, computing element 401 and computing element 402 exchange keep alive messages and port hints (step 506). Keep alive messages refresh NAT state in environments where idle timeouts are short, while port hints carry observations about external port assignments or predicted values that aid recovery if a NAT rebind occurs. For instance, computing element 402 might indicate that its NAT tends to allocate ports from a tight range or uses sequential increments; computing element 401 can then try those predicted ports first if it detects a loss of connectivity. The peers can further exchange timing guidance, backoff policies, and retry limits so that maintenance traffic remains efficient while preserving fast reconnection after mobility, power cycling, or transient link disruptions. These operations explain why the steps are performed: the goal is to sustain a private, authenticated, and confidential channel across changing address mappings without user intervention.

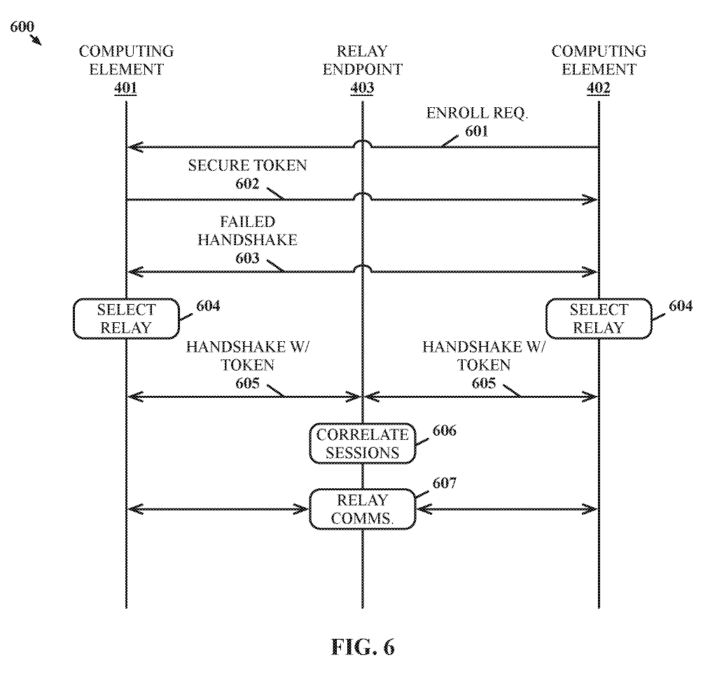

FIG. 6 illustrates operational scenario 600 for on‑the‑fly provisioning a private network between computing elements. Operational scenario 600 begins after computing element 402 has the IP address of computing element 401, which it may have obtained using steps similar to steps 501-502 above or via an out‑of‑band compact connection identifier 411. Computing element 402 sends an enrollment request to computing element 401 (step 601). The enrollment request is encrypted using the first public key and includes the second public key of computing element 402 and, optionally, an authentication credential identifying a device, a user, or both. Providing credentials here allows computing element 401 to bind subsequent authorization to the proper entity and to reject unauthorized enrollment attempts.

Computing element 401 sends a secure token to computing element 402 in response to the request (step 602). The secure token may be bound to at least the second public key, and can encode an expiration time, a usage scope limiting permitted communications, a revocation status, and a signature verifiable by computing element 402. In addition, computing element 401 may provide a traffic public key distinct from the enrollment key so that enrollment secrets do not persist into the data phase. This architecture clarifies why the token issuance step is performed: it establishes explicit authorization for the NAT handshake and later communications without relying on long‑term shared secrets, while giving either element a revocation switch and time‑bounded control.

Computing element 401 uses the secure token in a NAT handshake attempt that fails (step 603). Failure can occur due to symmetric NAT behavior, filtering of new flows, or transient reachability changes. Even when unsuccessful, the handshake attempt collects useful measurements and ensures both peers are live and authorized. In response to the failed handshake, computing elements 401-402 both select relay endpoint 403 to relay communications (step 604). Selection can be independent based on advertised relay endpoint(s) 403 and measured performance, or coordinated by one peer suggesting a relay identifier and the other confirming. Either approach preserves decentralization and permits geographically diverse relay deployments. Allowing both independent and coordinated selection widens applicability and avoids over‑narrowing the technique.

Computing element 401 and computing element 402 use the secure token when handshaking with relay endpoint 403 (step 605). The token authenticates each element to the relay, allowing the relay to verify authorization without learning the traffic keys. The token enables relay endpoint 403 to correlate the two sessions (step 606). Correlation may rely on a token identifier, a cryptographic binding, or a short‑lived session handle produced during enrollment, thereby allowing the relay to pair the correct ingress and egress flows even if the two elements connect to different relay frontends within the relay service.

Upon establishing the sessions, relay endpoint 403 relays communications between computing element 401 and computing element 402 (step 607). The relay forwards encrypted payloads without decryption; thus confidentiality remains end‑to‑end between the computing elements. If direct connectivity later becomes possible, either element may attempt a fresh NAT handshake using the previously issued token and port‑prediction hints; upon success, traffic can transition away from the relay without interrupting application flows. In deployments with multiple enrolled second computing elements, computing element 401 can enforce a client‑isolation policy preventing the second computing elements from communicating with one another over the private connection, while still permitting each to communicate with computing element 401. This isolates clients while preserving manageability.

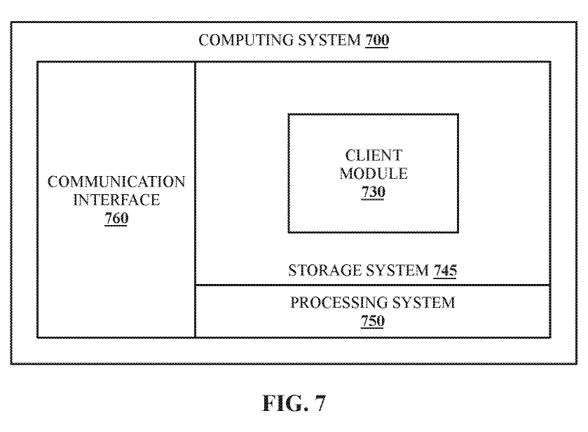

FIG. 7 illustrates computing system 700 for on-the-fly provisioning a private network between computing elements. Computing system 700 is representative of any computing system or systems with which the various operational architectures, processes, scenarios, and sequences disclosed herein can be implemented. Computing system 700 is an example architecture for computing elements 101-102, 401-402, relay endpoint(s) 403, DNS 404, although other examples may exist. Computing system 700 includes storage system 745, processing system 750, and communication interface 760. Processing system 750 is operatively linked to communication interface 760 and storage system 745. Communication interface 760 may be communicatively linked to storage system 745 in some implementations. Computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format – including combinations thereof. Communication interface 760 may be configured to communicate with other computing systems via one or more networks.

Processing system 750 comprises microprocessor and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 745, or any other computer-readable storage medium herein, be considered a transitory form of signal transmission (often referred to as "signals per se"), such as a propagating electrical or electromagnetic signal or carrier wave.

Processing system 750 is typically mounted on a circuit board that may also hold the storage system. The operating software of storage system 745 comprises computer programs, firmware, or some other form of machine-readable program instructions. The operating software of storage system 745 comprises client module 730. The operating software on storage system 745 may further include an operating system, utilities, drivers, network interfaces, applications, or some other type of software. When read and executed by processing system 750 the operating software on storage system 745 directs computing system 700 to create a private connection between computing elements. Client module 730 may execute natively on processing system 750 or the operating software may include virtualization software, such as a hypervisor, to virtualize computing hardware on which client module 730 executes.

In at least one example, client module 730 executes on processing system 750 and directs processing system 750 to advertise private communication information including a first public key for encrypting data in encapsulated packets directed to the first element and a public Internet Protocol (IP) address of the computing system. Client module 730 further directs processing system 750 to receive a message from a second computing element. The message is encrypted using the first public key and includes a second public key for the second computing element. Client module 730 also directs processing system 750 to decrypt the message at the first computing element using a first private key and, in response to receiving the message, create a secure token and providing the secure token to the second computing element with a second public key. Client module 730 directs processing system 750 to perform a Network Address Translation (NAT) handshake between the first and second computing elements using the token for authentication and the second public key to encrypt communications directed to the first computing element.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for establishing a private network, the method comprising:
advertising, from a first computing element, private communication information including a first public key for encrypting data in encapsulated packets directed to the first element and a public Internet Protocol (IP) address of the first computing element;
receiving a message at the first computing element from a second computing element, wherein the message is encrypted using the first public key and includes a second public key for the second computing element;
decrypting the message at the first computing element using a first private key;
in response to receiving the message, creating a secure token and providing the secure token to the second computing element with a second public key; and
performing a Network Address Translation (NAT) handshake between the first and second computing elements using the token for authentication and the second public key to encrypt communications directed to the first computing element.

2. The method of claim 1, wherein the advertising comprises:
providing, in association with the first public key, one or more relay endpoints usable by the second computing element to bootstrap connectivity to the first computing element prior to completion of the NAT handshake, and wherein at least one of the relay endpoints is selected based on reachability or latency.

3. The method of claim 1, wherein the first computing element and the second computing element are each located behind respective NAT environments, and the NAT handshake comprises coordinating simultaneous outbound connectivity attempts by the first and second computing elements to establish a direct path between the first and second computing elements.

4. The method of claim 1, wherein the message from the second computing element includes an authentication credential, and wherein creating the secure token comprises:
verifying the authentication credential; and
binding the token to at least the second public key.

5. The method of claim 4, wherein the secure token includes one or more of:
an expiration time,
a usage scope limiting permitted communications,
a revocation status, and
a signature verifiable by the second computing element.

6. The method of claim 1, wherein the private communication information is encoded in a compact connection identifier comprising the first public key and endpoint metadata, the compact connection identifier being represented in a printable character encoding or scannable visual code and distributable via at least one of a text record in a name‑resolution system and an optical code displayed by the first computing element.

7. The method of claim 1, comprising:
configuring the private network such that the second computing element is permitted to communicate with the first computing element while being prevented from discovering or directly communicating with other computing elements enrolled with the first computing element.

8. The method of claim 1, comprising:
upon failure to establish a direct path between the first and second computing elements in the NAT handshake, relaying subsequent encrypted communications between the first computing element and the second computing element via a relay endpoint.

9. The method of claim 1, wherein:
advertising the private communication information comprises publishing a first public key for enrollment messaging distinct from a traffic public key; and
providing the second public key to the second computing element comprises providing a traffic public key to be used by the second computing element for subsequent communications.

10. The method of claim 1, wherein performing the NAT handshake comprises:
exchanging keepalive messages and port‑prediction hints to maintain or re‑establish connectivity in response to NAT state changes.

11. A system for establishing private communications between computing elements, the system comprising:
a first computing element configured to:
advertise private communication information including a first public key and a public network address;
receive from a second computing element a message encrypted using the first public key and including a second public key;
decrypt the message using a first private key corresponding to the first public key;
create a secure token in response; and
participate in a Network Address Translation (NAT) handshake authenticated by the secure token;
the second computing element configured to:
obtain the private communication information;
encrypt and transmit the message including the second public key;
receive the secure token and a public key from the first computing element for subsequent communications; and
participate in the NAT handshake to establish a private connection with the first computing element; and
at least one relay service reachable by the first and second computing elements and configured to:
provide bootstrap signaling to the first and second computing elements.

12. The system of claim 11, wherein the first computing element is configured to:
encode the private communication information as a connection identifier comprising at least the first public key and one or more endpoint descriptors; and
publish the connection identifier through a name‑resolution record accessible to the second computing element.

13. The system of claim 12, wherein the first computing element is configured to:
display the connection identifier as a machine‑readable visual code that the second computing element captures to initiate enrollment.

14. The system of claim 11, wherein the first computing element is configured to:
admit a number of the second computing elements that are not pre‑registered when the advertising occurs; and
issue distinct secure tokens to respective ones of the number of the second computing elements during enrollment.

15. The system of claim 11, wherein the second computing elements are preauthorized and identified by one or more of: device public keys, user identities, and enrollment secrets.

16. The system of claim 11, wherein the first computing element is configured to:
enforce a client‑isolation policy preventing the second computing elements from communicating with one another over the private connection.

17. The system of claim 11, wherein the at least one relay service comprises a plurality of geographically diverse relay endpoints, and the second computing element is configured to:
select a relay endpoint based on measured performance characteristics or availability of the relay endpoint.

18. An apparatus for establishing private communications between computing elements, the apparatus comprising:
one or more computer‑readable storage media;
one or more processing systems operatively coupled with the one or more computer‑readable storage media; and
program instructions stored on the one or more computer‑readable storage media that, when read and executed by the one or more processing systems, direct the apparatus to:
generate a connection advertisement including a first public key for encrypted enrollment messages and a reachable network address of the computing apparatus;
publish the connection advertisement;
receive, from a remote computing element, an enrollment message encrypted using the first public key and including a second public key of the remote computing element;
issue a secure token bound at least to the second public key;
transmit the secure token and a public key for subsequent private communications to the remote computing element; and
participate in a Network Address Translation (NAT) traversal handshake with the remote computing element using the secure token for authentication.

19. The apparatus of claim 18, wherein to publish the connection advertisement, the program instructions direct the apparatus to:
relay traffic between the remote computing element and another remote computing element when establishment of a direct connection therebetween fails.

20. The apparatus of claim 18, wherein to issue the secure token, the program instructions direct the apparatus to:
set an expiration;
record a revocation status; and
rotate at least one public/private key pair without interrupting an established private connection.
